(19) United States
(12) Patent Application Publication
(10) Pub. No.: US 2022/0379671 A1
(43) Pub. Date: Dec. 1, 2022

(54) Tire Traction Enhancing Apparatus

(71) Applicant: Christopher Jones, Jacksonville, AR (US)

(72) Inventor: Christopher Jones, Jacksonville, AR (US)

(21) Appl. No.: 17/683,906

(22) Filed: Mar. 1, 2022

Related U.S. Application Data
(60) Provisional application No. 63/192,611, filed on May 25, 2021.

(51) Int. Cl. B60C 27/06

(52) U.S. Cl. CPC B60C 27/067

(57) ABSTRACT

The present invention relates to a novel and easy to use tire traction-enhancing tool that is used for increasing traction of a tire stuck in snow, ice, mud and/or other environmental hazards that prohibit or obstruct movement of a vehicle. The tool features a plurality of steel or aluminum chains welded together in a mat or rectilinear configuration that is configured to be securely deployed underneath a stuck vehicle tire. The chains are formed of pre-bent welded links and the chains are connected to each other through connecting links. The tool is lightweight, portable, easy to deploy and remove and can be stored in the trunk of the vehicle. The tool is not required to be mounted to the tire and thus increases the life of the tire and the effectiveness of traction provided to the tire.

### CROSS-REFERENCE TO RELATED APPLICATION

The present application claims priority to, and the benefit of, U.S. Provisional Application No. 63/192,611, which was filed on May 25, 2021 and is incorporated herein by reference in its entirety.

### FIELD OF THE INVENTION

The present invention relates generally to the field of traction devices. More specifically, the present invention relates to a novel tire traction device that can be easily placed underneath a tire stuck in ice, snow or mud to unstick and move the vehicle. More specifically, the traction tool enhances traction of the tire and increases engagement forces to overcome skidding and slipping of the tire. The tool features several steel or aluminum chains welded together in a rectilinear configuration that fit securely underneath a vehicle tire. The chains allow the tire to improve traction on the roadway to facilitate movement. Accordingly, the present disclosure makes specific reference thereto. Nonetheless, it is to be appreciated that aspects of the present invention are also equally applicable to other like applications, devices and methods of manufacture.

### BACKGROUND

By way of background, vehicle tires are usually not suitable for use in snowy road and muddy conditions. In particular, when a vehicle remains stationary in snow or mud for a long period of time, such as throughout the night or for long hours in a parking setting, the problem of one or more vehicle tires becoming stuck in ice and snow can commonly be faced by individuals. A vehicle becoming stuck in snow, ice, or mud is extremely frustrating for individuals. They generally require external help, such as a towing vehicle, to get the vehicle out. This is not only time-consuming, but extremely expensive.

Tire manufacturers have started making snow tires that have a tread design with larger gaps between the treads when compared to conventional tires. However, such tires can be ineffective when individuals find their vehicles stuck in snow or mud, wherein the vehicle faces the same problem of being extricated from the stuck position.

Other ways of increasing traction and to get the vehicle out require the use of a vehicle jack to lift the vehicle to create a gap between the snow/ice/mud and the tires there above. This is again time-consuming and may not be possible to be performed by all users. Further, it has been a practice to put standard chains or cable chains on tires for use on snow covered surfaces. However, the fitting of such cables or chains is cumbersome and time-consuming.

Therefore, there exists a long felt need in the art for an improved tire traction device that easily enhances tire traction and provides mobility of a vehicle when stuck in snow, ice or mud. There is also a long felt need in the art for a tire traction-enhancing tool that is quick to deploy and easy to use. Additionally, there is a long felt need in the art for a tire traction-enhancing tool that can be deployed by a single individual without requiring any external help. Moreover, there is a long felt need in the art for a traction device that provides an inexpensive way of getting vehicles unstuck that are stuck in snow, ice or mud. Further, there is a long felt need in the art for a traction tool that is easy to deploy and remove. Furthermore, there is a long felt need in the art for an improved traction device that is lightweight and can be stored in the vehicle for ready access. Finally, there is a long felt need in the art for a traction device that offers a simple method of moving a stuck vehicle from or through, snow, ice, mud and other environmental hazards.

The subject matter disclosed and claimed herein, in one embodiment thereof, comprises a tire traction-enhancing apparatus. The tire traction-enhancing apparatus helps vehicle tires to gain traction and ultimately move when stuck in snow, ice or mud. The tool has a plurality of link chains, each link chain includes a plurality of pre-bent welded links, wherein the alternate links are vertically-oriented and horizontally-oriented. The link chains are connected to each other using connecting links that are welded to the chains. The tool is configured to be placed underneath a tire that is stuck in ice, snow, or mud to increase traction and to move the vehicle easily without lifting a tire(s) from the ground.

In this manner, the tire traction-enhancing apparatus of the present invention accomplishes all of the forgoing objectives and provides users with a traction device designed to help vehicles gain traction and ultimately provide mobility in inclement weather conditions. The tool can be easily deployed underneath a vehicle tire, and allows users to maintain traction on a roadway to get their vehicle unstuck via the chains. The tool can be stored easily in the vehicle or any other location.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tire traction-enhancing tool. The tire traction-enhancing tool is designed to help vehicle tires gain traction and ultimately provide mobility to the vehicle when stuck in snow, ice or mud. The tool further comprising a plurality of link chains, each link chain includes a plurality of welded links wherein the alternate links are vertically-oriented and horizontally-oriented, a first link chain of the plurality of link chains is connected to a second link chain of the plurality of chains using connecting links wherein each horizontal-oriented link of the first link chain is connected to an adjacent horizontal-oriented link of the second link chain, and each vertical-oriented link of the first link chain is connected to adjacent vertical-oriented link of the second link chain. Further, each horizontal-oriented link of the second link chain is connected to the adjacent horizontal-oriented link of the third link chain of the plurality of the link chains.

In yet another embodiment, the connection between the first link chain and the second link chain is repeated between the third link chain and a fourth link chain.

In yet another embodiment, the tool is flexible, and can be formed using butt welding or flash welding techniques.

In yet another embodiment of the present invention, the tool is made from a rust-free and weatherproof metal such as aluminum or stainless steel.

In yet another embodiment, a method for enhancing traction for a tire for getting the vehicle unstuck from snow, ice or mud is disclosed. The method includes the steps of initially providing a traction tool, wherein the traction tool is a generally rectilinear arrangement of metal chains welded together. The method includes placing the tool underneath the tire which is stuck in snow, ice or mud, and moving the tire in a forward or a rear direction, thereby enabling an increase to the engagement forces with the tire. Finally, the traction tool is removed and stored in the trunk of the vehicle.

In yet another embodiment of the present invention, a tire traction tool for moving a vehicle stuck in snow, ice or mud is disclosed. The tool features a plurality of steel or aluminum chains, each chain having pre-bent links welded together in alternate horizontal and vertical orientations, each chain is connected to the subsequent chain, forming a rectilinear mesh of pre-bent links, the rectilinear mesh is configured to place underneath a tire that is stuck in the snow, ice, or mud such that the tire engages with the tool and the tool increases engagement forces of the tire to move the tire and to unstick same from the snow, ice or mud.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle tire traction device of the present invention in accordance with the disclosed architecture;

FIG. 2 illustrates a perspective view of the tire traction-enhancing apparatus of the present invention showing the flexible nature of the device in accordance with the disclosed architecture;

FIG. 3 illustrates an exemplary method of joining links to form the tire traction tool of the present invention in accordance with the disclosed architecture;

FIG. 4 illustrates a perspective view showing a user placing the tire traction-enhancing apparatus of the present invention under a tire of a vehicle for providing traction in accordance with the disclosed architecture; and

FIG. 5 illustrates a perspective view showing the user storing the tire traction-enhancing apparatus in a trunk of the vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved tire traction device that easily enhances tire traction and provides mobility of a vehicle when stuck in snow, ice, or mud. There is also a long felt need in the art for a tire traction enhancing tool that is quick to deploy and easy to use. Additionally, there is a long felt need in the art for a tire traction enhancing tool that can be deployed by a single individual without requiring any external help. Moreover, there is a long felt need in the art for a traction device that provides an inexpensive way of getting vehicles unstuck that are stuck in snow, ice or mud. Further, there is a long felt need in the art for a traction tool that is easy to deploy and remove. Furthermore, there is a long felt need in the art for an improved traction device that is lightweight and can be stored in the vehicle for ready access. Finally, there is a long felt need in the art for a traction device that offers a simple method of moving a stuck vehicle from, or through, snow, ice, mud and other environmental hazards.

The present invention, in one exemplary embodiment, is a novel tire traction tool for moving a vehicle that is stuck in snow, ice or mud. The tool has a plurality of steel or aluminum chains, each chain having pre-bent links welded together in an alternate horizontal and vertical orientation. Each chain is connected to the adjacent chains, forming a rectilinear mesh of pre-bent links and the rectilinear mesh is configured to place underneath a tire that is stuck in the snow, ice or mud, such that the tire engages with the tool and the tool increases engagement forces of the tire to provide mobility to the tire and unstick same from the snow, ice or mud.

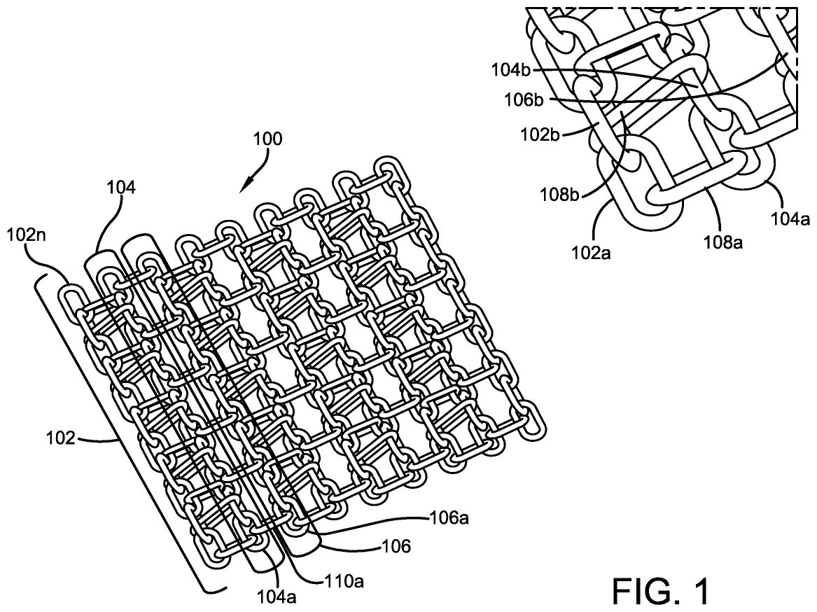

Referring initially to the drawings, FIG. 1 illustrates a perspective view of one potential embodiment of the vehicle tire-traction device 100 of the present invention in accordance with the disclosed architecture. The traction device 100 of the present invention is designed to help vehicles gain improved traction over slippery surfaces and ultimately provide mobility in inclement weather conditions. More specifically, the traction device 100 is placed under a tire of a vehicle for gripping icy or snow packed surfaces and is in the form of a rectilinear metal mat-like device formed of a plurality of metal linked chains that are welded together. The traction device 100 has a plurality of linked chains connected to each other through welded links. As shown, the first linked chain 102 and the second linked chain 104 are of substantially the same length and have the same number of welded links. Each link of the first linked chain 102 is connected to the corresponding link of the second linked chain 104 through a welded link. In one exemplary arrangement, the first link 102a of the first linked chain 102 is connected to the first link 104a of the second linked chain 104 through a first connecting welded link (i.e. vertically aligned link) 108a. Similarly, the second link 102b of the first linked chain 102 is connected to the second link 104b of the second linked chain 104 through a second connecting welded link (i.e. vertically aligned link) 108b. Similarly, all the links up to 102n of the first chain 102 are connected to the corresponding links up to 104n of the second chain 104 through corresponding connecting generally vertically aligned welded links.

A unique feature of the traction device 100 is that the first link of each linked chain 102,104,106 and others is horizontally-positioned and the second link of each chain is vertically-positioned. Similarly, alternate links of each chain are positioned horizontally and vertically. An advantage of the aforementioned orientation or arrangement is that it provides a better traction ‘metal mat’ for wheels of a vehicle on any type of surface.

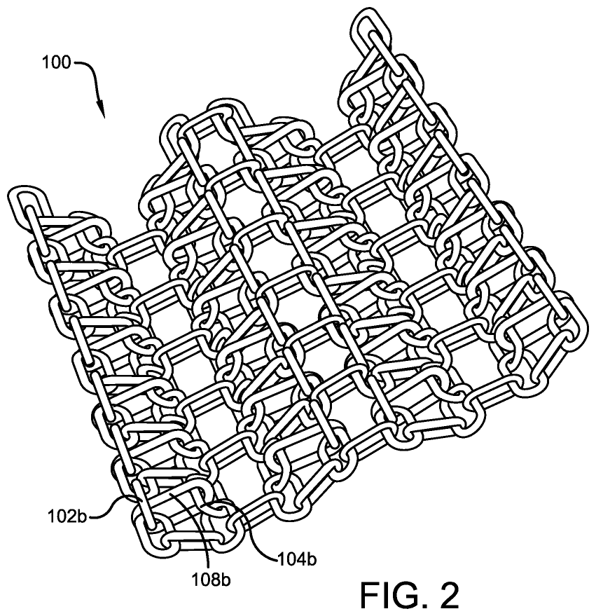

Now, the connection of the second linked chain 104 and the subsequent (third) linked chain will be described. It should be noted that only the horizontally-positioned links of the second linked chain 104 and the third linked chain 106 are connected through the connecting links. As shown, the horizontally-positioned first link 104a of the second chain 104 is connected to the horizontally positioned first link 106a of the third chain 106 through a generally vertically aligned connecting link 110a. The vertically-oriented links of the second chain 104 and the third chain 106 are not connected to each other. As shown, the vertical link 104b of the second chain 104 is not connected to the vertical link 106b. Thus, it should be understood that horizontally-oriented links of one chain are attached to adjacent horizontally-oriented links of the adjacent chain, however the vertically-oriented links are connected to adjacent vertically-oriented links in an alternate manner. Thus, vertical links of the first chain 102 are connected to vertical links of the second chain 104, but the vertical links of the second chain 104 are not connected to the vertical links of the third chain 106. This unique arrangement makes the traction device 100 flexible, foldable or rollable (as shown in FIG. 2) such that the device 100 can be partially folded, rolled or bent and also leads to better traction on the roadway to facilitate movement.

The traction device 100 can have any number of linked chains that form the traction device 100 in a regular rectilinear shape. The linked chains and the connecting links can be formed of any metal such as aluminum, and can also be formed of stainless steel. The material of the chains is rust-free, weatherproof and lightweight.

FIG. 2 illustrates a perspective view of the tire traction-enhancing apparatus 100 of the present invention showing the movable, rotatable and flexible nature of the device in accordance with the disclosed architecture. The connecting links connecting the vertically-oriented links of alternate chains allow a user to fold, rotate or bend the device 100. As shown as an example, the vertical-oriented link 102b and the vertical-oriented link 104b connecting through connecting link 108b are able to move along, or rotate relative to, the connecting link 108b, thus providing flexibility and rotatability of the device 100. Similarly, when a user tries to fold or roll the device 100, the vertical links allow the device 100 to be folded and/or rolled, and thus increasing portability and providing easy storage of the device 100.

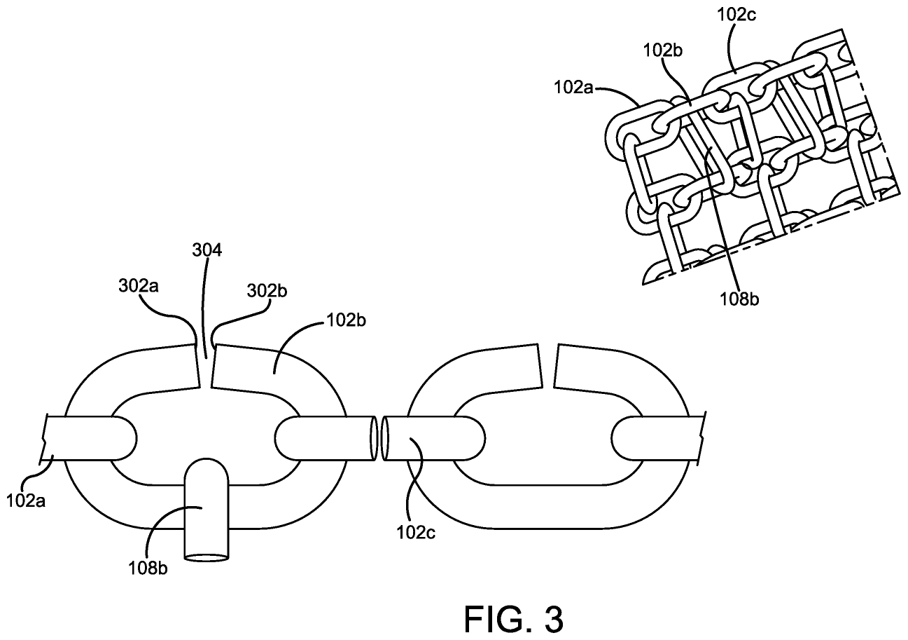

FIG. 3 illustrates an exemplary method of joining links to form the tire traction tool 100 of the present invention in accordance with the disclosed architecture. The traction tool 100 is formed of individual pre-bent links that have two terminal ends. As shown, the pre-bent vertical-oriented link 102b has a first terminal end 302a and a second terminal end 302b. A space 304 between the terminal ends 302a,302b allows horizontal links 102a,102c to be inserted into the pre-bent link 102b. Once the links 102a,102c are hung inside the link 102b, terminals 302a,302b are welded to each other using any conventional welding technique such as butt welding or flash welding. Similarly, the connecting link 108b is also hung inside the vertical link 102b. This prohibits the links 102a,102c from detaching from the link 102b. Similarly, the links are connected to each other in the desired orientation to form the rectilinear-shaped traction tool 100.

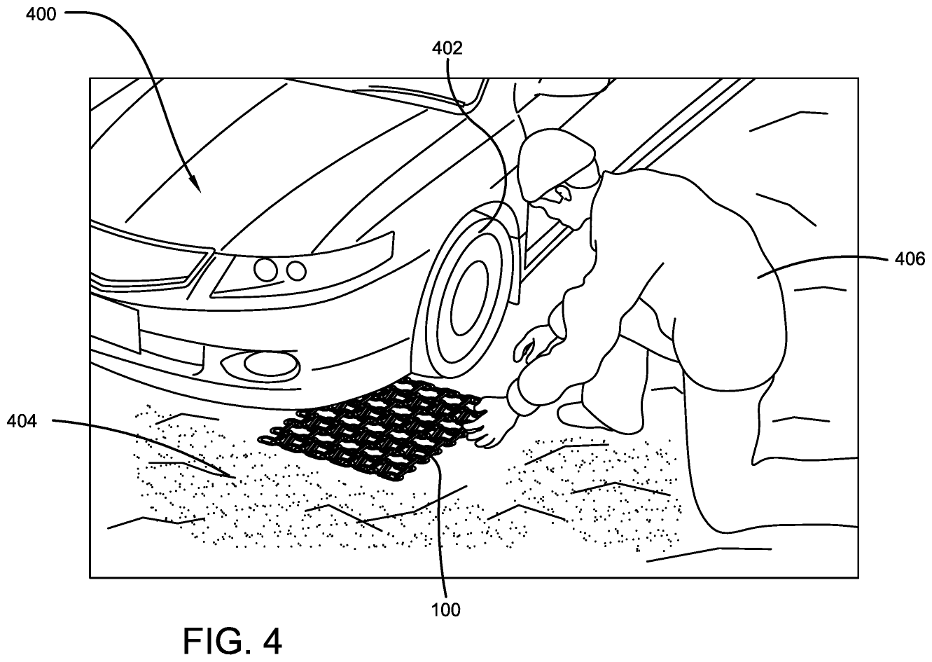

FIG. 4 illustrates a perspective view showing a user placing the tire traction-enhancing apparatus 100 of the present invention under a tire of a vehicle for providing traction in accordance with the disclosed architecture. As shown, a user 406 places the traction device 100 below the tire 402 of the vehicle 400 for improving traction to facilitate movement of the tire 402 thereover. The tool 100 is placed such that the tire 402 engages with the tool 100 during its motion and grips on the tool 100, thereby enabling traction and rotation of the tire 402. The welded chains of the tool 100 also prevent skidding of the tire 402 on snow 404 or on any type of slippery surface, or even when the tire 402 is stuck in a pothole or mudhole.

More specifically, the traction tool 100 prevents tire spin, thereby increasing the tread-to-surface friction of the tire 402. The tool 100 is useful for deep snow, ice and cold weather. Further, the tool 100 is easy to deploy and remove without using any tools, and is safe for both the tire and the ground. An advantage of the traction tool 100 of the present invention is that it works in a manner similar to traction chains attached to the tires, but the user 406 is not required to attach or mount the tool 100 to the tire 402. This increases the life of the tire 402 and the effectiveness of traction provided to the tire 402. The tire traction tool 100 is designed to increase engagement force with the tire 402 when the vehicle 400 moves forward or backward. The traction apparatus 100 is installable without the need to lift or jack the tire 402 off the ground.

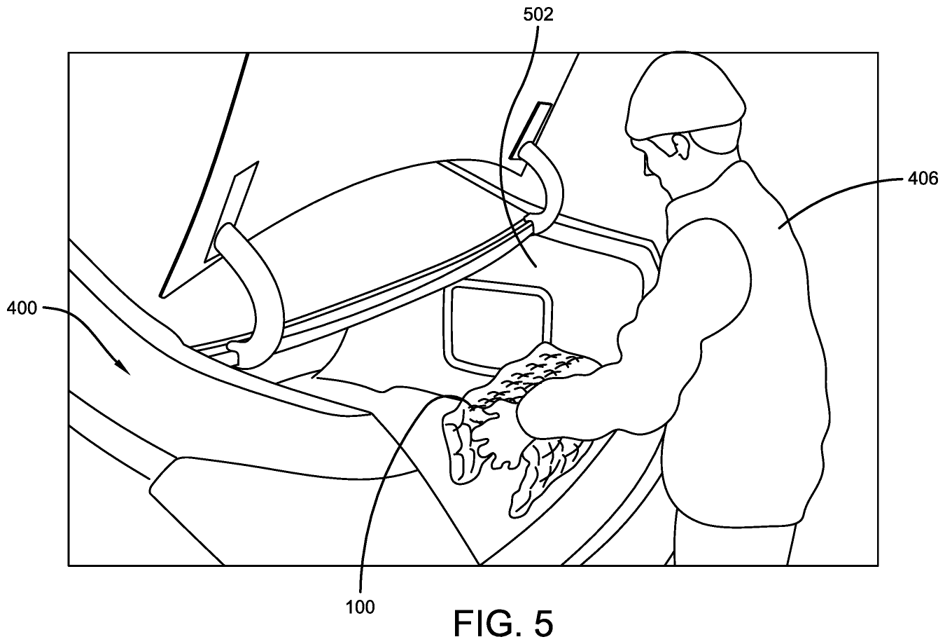

FIG. 5 illustrates a perspective view showing the user storing the tire traction-enhancing apparatus 100 in the trunk of the vehicle in accordance with the disclosed architecture. As stated earlier, the traction tool 100 is portable, lightweight, flexible, rollable and foldable. When not in use, the user 406 can store the tool 100 in the trunk 502 of the vehicle 400. The user 406 can partially fold and roll the tool 100 to conveniently store in the trunk 502 of the vehicle 400.

It should be appreciated that the tool 100 comes in various dimensions to fit for different sizes of the tires. In one embodiment, the tool 100 comprises a rectilinear shape with dimensions generally 3′×3′. Alternatively, the tool 100 can comprise a rectilinear shape with dimensions generally of 4′×4′ or 2′×2′.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tire traction tool”, “tire traction device”, “traction tool”, “tire traction-enhancing apparatus”, “tool”, and “device” are interchangeable and refer to the tire traction-enhancing apparatus 100 of the present invention.

Notwithstanding the forgoing, the tire traction-enhancing apparatus 100 of the present invention can be of any suitable size and configuration as is known in the art without affecting the overall concept of the invention, provided that it accomplishes the above-stated objectives. One of ordinary skill in the art will appreciate that the size, configuration and material of the tire traction-enhancing apparatus 100 as shown in the FIGS. are for illustrative purposes only, and that many other sizes and shapes of the tire traction-enhancing apparatus 100 are well within the scope of the present disclosure. Although the dimensions of the tire traction-enhancing apparatus 100 are important design parameters for user convenience, the tire traction-enhancing apparatus 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A traction device for placing under a tire of a vehicle for gripping a slippery surface, the traction device comprising:
a metal mat comprising a plurality of metal linked chains, wherein said plurality of metal linked chains include at least a first linked chain, a second linked chain and a third linked chain;
wherein each of the said first, second and third linked chains comprise a plurality of linked chain links;
wherein each link of said plurality of linked chain links from said first linked chain is linked to an adjacent link of said plurality of linked chain links from said second linked chain with a generally vertically aligned chain link; and
wherein every other link of said plurality of vertically linked chain links from said second linked chain is linked to every other adjacent link of said plurality of linked chain links from said third linked chain with a generally vertically aligned chain link.

2. The traction device of claim 1, wherein each said plurality of linked chain links are welded links.

3. The traction device of claim 2, wherein each said generally vertically aligned chain link is a welded chain link.

4. The traction device of claim 1 further comprising a fourth linked chain including a plurality of linked chain links, wherein each link of said plurality of linked chain links from said third linked chain linked to an adjacent link of said plurality of linked chain links from said fourth linked chain with a generally vertically aligned chain link.

5. The traction device of claim 4 further comprising a fifth linked chain including a plurality of linked chain links, wherein every other link of said plurality of linked chain links from said fourth linked chain linked to every other adjacent link of said plurality of linked chain links from said fourth linked chain with a generally vertically aligned chain link.

6. The traction device of claim 1, wherein said first linked chain, said second linked chain, and said third linked chain are of substantially the same length and include the same number of chain links.

7. The traction device of claim 5, wherein said first linked chain, said second linked chain, said third linked chain, said fourth linked chain, and said fifth linked chain are of substantially the same length and include the same number of chain links.

8. The traction device of claim 1, wherein said metal mat is rectilinear in shape.

9. The traction device of claim 7, wherein said metal mat is rollable.

10. The traction device of claim 7, wherein said metal mat is foldable.

11. The traction device of claim 7, wherein said metal mat is flexible.

12. A traction device for placing under a tire of a vehicle for gripping a slippery surface, the traction device comprising:
a metal mat including a plurality of metal linked chains, wherein said plurality of metal linked chains include at least a first linked chain, a second linked chain, a third linked chain and a fourth linked chain;
wherein said first linked chain includes a plurality of linked chain links, wherein connecting chain links alternate between generally horizontal alignment and generally vertical alignment;
wherein said second linked chain includes a plurality of linked chain links, wherein connecting chain links alternate between generally horizontal alignment and generally vertical alignment;
wherein said third linked chain includes a plurality of linked chain links, wherein connecting chain links alternate between generally horizontal alignment and generally vertical alignment;
wherein said fourth linked chain includes a plurality of linked chain links, wherein connecting chain links alternate between generally horizontal alignment and generally vertical alignment;
wherein each link of said plurality of linked chain links from said first linked chain linked to an adjacent link of said plurality of linked chain links from said second linked chain with a generally vertically aligned chain link;
wherein every other link of said plurality of linked chain links from said second linked chain linked to every other adjacent link of said plurality of linked chain links from said third linked chain with a generally vertically aligned chain link; and
wherein each link of said plurality of linked chain links from said third linked chain linked to an adjacent link of said plurality of linked chain links from said fourth linked chain with a generally vertically aligned chain link.

13. The traction device of claim 12, wherein each said plurality of linked chain links are welded links.

14. The traction device of claim 12, wherein each said generally vertically aligned chain link is a welded chain link.

15. The traction device of claim 12 further comprising a fifth linked chain including a plurality of linked chain links, wherein every other link of said plurality of linked chain links from said fourth linked chain linked to every other adjacent link of said plurality of linked chain links from said fourth linked chain with a generally vertically aligned chain link.

16. The traction device of claim 12, wherein said first linked chain, said second linked chain, said third linked chain, and said fourth linked chain are of substantially the same length and include the same number of chain links.

17. The traction device of claim 12, wherein said metal mat is rollable.

18. A traction device for placing under a tire of a vehicle for gripping a slippery surface, the traction device comprising:
a metal mat including a plurality of metal linked chains, wherein said plurality of metal linked chains include at least a first linked chain, a second linked chain, a third linked chain and a fourth linked chain;
wherein said first linked chain includes a plurality of linked chain links, wherein connecting chain links alternate between generally horizontal alignment and generally vertical alignment;
wherein said second linked chain includes a plurality of linked chain links, wherein connecting chain links alternate between generally horizontal alignment and generally vertical alignment;
wherein said third linked chain includes a plurality of linked chain links, wherein connecting chain links alternate between generally horizontal alignment and generally vertical alignment;
wherein said fourth linked chain includes a plurality of linked chain links, wherein connecting chain links alternate between generally horizontal alignment and generally vertical alignment;
wherein each link of said plurality of linked chain links from said first linked chain linked to an adjacent link of said plurality of linked chain links from said second linked chain with a generally vertically aligned chain link;
wherein said plurality of linked chain links having said generally horizontal alignment from said second linked chain linked to said plurality of linked chain links having said generally horizontal alignment from said third linked chain with a generally vertically aligned chain link; and
wherein each link of said plurality of linked chain links from said third linked chain linked to an adjacent link of said plurality of linked chain links from said fourth linked chain with a generally vertically aligned chain link.

19. The traction device of claim 18, wherein said first linked chain, said second linked chain, said third linked chain, and said fourth linked chain are of substantially the same length and include the same number of chain links.

20. The traction device of claim 19, wherein said metal mat is rollable.
